(19) United States
(12) Patent Application Publication
(10) Pub. No.: US 2014/0085633 A1
(43) Pub. Date: Mar. 27, 2014

(54) Wavenumber-Linearized Spectrometer on Chip in a Spectral-Domain Optical Coherence Tomography System

(71) Applicants: Kyle Preston, Groton, NY (US); Arthur Nitkowski, Ithaca, NY (US)

(72) Inventors: Kyle Preston, Groton, NY (US); Arthur Nitkowski, Ithaca, NY (US)

(21) Appl. No.: 14/035,322

(22) Filed: Sep. 24, 2013

Related U.S. Application Data
(60) Provisional application No. 61/704,890, filed on Sep. 24, 2012.

(51) Int. Cl. G01J 3/28; G01B 9/02

(52) U.S. Cl. CPC G01J 3/28; G01B 9/02091
USPC 356/326

(57) ABSTRACT

Various embodiments of apparatuses, systems and methods are described herein related to a spectrometer that can generate a plurality of narrowband optical signals having a wavenumber linear format without using an increased number of optical components and without an increase in signal processing.

### CROSS REFERENCE TO RELATED APPLICATION

This application claims the benefit of U.S. Provisional Application No. 61/704,890 filed on Sep. 24, 2012 and the contents of Application No. 61/704,890 are hereby incorporated by reference in their entirely.

### FIELD

The various embodiments described herein generally relate to an apparatus and method for implementing a wavenumber-linearized spectrometer on a chip.

### BACKGROUND

An optical spectrometer is a system that is used to sample the spectral components of a broadband optical signal. In a general case, dispersive spectrometers use a dispersive element, such as a diffraction grating, to spatially distribute the spectral components of the optical signal that is being analyzed. In other words, a spatially dispersed spectrum is generated by the dispersive element. The dispersed spectrum of the optical signal is then sampled and measured by a linear array of detectors (e.g. a detection array) to provide a set of output samples.

A grating-based spectrometer tends to disperse the spectral components of an optical signal received by the spectrometer linearly with respect to wavelength. This can be seen from the well-known grating equation shown in equation 1:

d(sin θᵢ+sin θₘ)=mλ/n, (1)

with grating pitch d, input angle θᵢ, output angle θₘ, mode order m, wavelength λ, and effective index of refraction n. It can be shown that to a first order, the output angular dispersion is linearly related to the change in wavelength δλ as shown in equation 2.

δθₘ=δλ×m/(d cos θₘ) (2)

Within a small angle approximation, when the dispersed spectrum is focused onto a detector array, there is a linear relationship between a position on the detector and the wavelength at that position. This is defined as a linear wavelength format of the dispersed spectrum. Similarly, the output samples provided by the detector array represent narrowband signals whose center wavelengths are equally spaced with respect to wavelength, which is defined as a linear wavelength format of the output samples.

Hence, the vast majority of dispersive spectrometers have output samples that are substantially equally spaced in wavelength. However, this is not ideal for every application. For example, conventional Spectral Domain Optical Coherence Tomography (SD-OCT) systems which use a spectrometer to acquire data require additional optical elements or additional signal processing in order to obtain OCT images from the data measured by the detection array. The additional optical elements or additional signal processing are used to remap the output samples from conventional OCT spectrometers from a linear wavelength format to a linear wavenumber format, resulting in output samples that are equally spaced in wavenumber k. The resulting interpolation is costly in time and computing power, and generates residual artifacts which degrade the fidelity and quality of the OCT imagery.

### SUMMARY OF VARIOUS EMBODIMENTS

In a broad aspect, at least one embodiment described herein provides a spectrometer for use with a Spectral Domain Optical Coherence Tomography (SD-OCT) system, the spectrometer comprising a dispersive element configured to generate a dispersed spectrum in a linear wavelength format from an input optical signal received by the spectrometer; a waveguide array coupled to the dispersive element and having a plurality of waveguides with input ports being configured to receive and sample the dispersed spectrum to generate a plurality of narrowband optical signals in a linear wavenumber format; and a detector array coupled to the waveguide array to receive and measure the plurality of narrowband optical signals having a linear wavenumber format and generate output samples having a linear wavenumber format.

In at least some embodiments, the input ports of the plurality of waveguides may be spaced apart non-linearly along an output of the dispersive element.

In at least some embodiments, the input ports of the plurality of waveguides may be spaced apart non-linearly along an output focal curve of the dispersive element.

In at least some embodiments, an input pitch of the plurality of waveguides in the waveguide array may be non-linearly spaced such that the center wavelengths of the narrowband optical signals captured by the plurality of waveguides are linearly spaced in wavenumber at the output of the waveguide array.

In at least some embodiments, the input ports of the waveguides may have widths that are sized so that the bandwidth of each narrowband optical signal from the plurality of narrowband optical signals is substantially constant in wavenumber.

In at least some embodiments, the number of generated output samples may be equal to 2̂n where n is an integer.

In at least some embodiments, the spectrometer may be located on a substrate.

In at least some embodiments, one or more components of the spectrometer may be located on a substrate.

In at least some embodiments, the waveguide array may be located on a substrate.

In at least some embodiments, at least one of the dispersive element and the detector array may not be located on the substrate.

In at least some embodiments, the dispersive element and the waveguide array may be located on a shared substrate and the detector array is not located on the shared substrate.

In at least some embodiments, a wavenumber value for an i^{th} waveguide of the waveguide array may be generated to have a desired central wavenumber k₀ and a wavenumber spacing δk according to: kᵢ=k₀+i*δk.

In at least some embodiments, an i^{th} linearly-spaced wavenumber kᵢ may be related to an i^{th} nonlinearly-spaced wavelength λᵢ according to: λᵢ=2π/kᵢ.

In another broad aspect, at least one embodiment described herein provides a Spectral Domain Optical Coherence Tomography (SD-OCT) system comprising a light source configured to provide an input optical signal; a splitter coupled to the light source, the splitter configured to split the input optical signal into first and second portions; a reference arm coupled to the splitter to receive the first portion of the input optical signal and provide a reference optical signal back to the splitter; a sample arm coupled to the splitter to receive the second portion of the input optical signal and provide a sample optical signal to the splitter; a spectrometer coupled to the splitter to receive an interference signal resulting from a combination of the reference optical signal and the sample optical signal and generate output samples, the output samples being representative of the interference signal and linearly spaced in wavenumber; and a computing device coupled to the spectrometer to receive the output samples and generate an image based on the interference signal, wherein one or more components of the system are formed on a substrate.

The spectrometer may be defined according to the various embodiments taught herein.

In at least some embodiments, the spectrometer may comprise a dispersive element configured to generate a dispersed spectrum in a linear wavelength format based on the spectrum of the interference signal; a waveguide array coupled to the dispersive element and having a plurality of waveguides with input ports being configured to receive and sample the dispersed spectrum to generate a plurality of narrowband optical signals in a linear wavenumber format; and a detector array coupled to the waveguide array to receive and measure the plurality of narrowband optical signals having a linear wavenumber format and generate output samples having a linear wavenumber format.

In at least some embodiments, the interference signal received by the spectrometer is made up of a plurality of narrowband optical signals in a linear wavenumber format.

In at least some embodiments, the system may have at least two components on different substrates.

In at least some embodiments, the system may further comprise an optical comb filter configured to receive input optical signals and generate the plurality of narrowband optical signals to have a linear wavenumber format, wherein the spectrometer comprises a dispersive element and a detector array coupled to the dispersive element.

In at least some embodiments, the optical comb filter may be configured to generate optical light signals to have bandwidths that are smaller than an optical channel spacing of detector pixels of the detector array.

In at least some embodiments, the optical comb filter may comprise one of a microring resonator, a racetrack resonator, a microdisk resonator, a whispering-gallery-mode resonator, or a Fabry-Perot resonator.

In at least some embodiments, the optical subsystem may further comprise a waveguide array that is disposed to couple outputs of the dispersive element to inputs of the detector array.

In at least some embodiments, the optical comb filter may be coupled between the splitter and the dispersive element.

In at least some embodiments, the optical comb filter may be coupled between the light source and the splitter.

In at least some embodiments, the dispersive element and the optical comb filter may be formed on a common substrate.

In at least some embodiments, the light source and the optical comb filter may be formed on a common substrate.

In at least some embodiments, the light source may be configured to output a frequency comb consisting of a plurality of narrowband optical signals in a linear wavenumber format.

In another broad aspect, at least one embodiment described herein provides a use in a SD-OCT system of a waveguide array in a spectrometer, the waveguide array having a plurality of waveguides with input ports being configured to receive and sample a dispersed spectrum that is generated by a dispersive element of the spectrometer, such that the waveguide array generates a plurality of narrowband optical signals in a linear wavenumber format.

In yet another aspect, at least one embodiment described herein provides a method for analyzing an input optical signal using a spectrometer with an SD-OCT system, wherein the method comprises: receiving the input optical signal; generating a dispersed spectrum of the input optical signal using a dispersive element, the dispersed spectrum being in a linear wavelength format; receiving and sampling the dispersed spectrum at a waveguide array having a plurality of waveguides to generate a plurality of narrowband optical signals in a linear wavenumber format; receiving and measuring the plurality of narrowband optical signals having a linear wavenumber format using a detector array; and generating output samples having a linear wavenumber format using the detector array.

In yet another broad aspect, at least one embodiment described herein provides an optical subsystem for use with a Spectral Domain Optical Coherence Tomography (SD-OCT) system, the optical subsystem comprising an optical comb filter for receiving input light signals and generating output light signals with components that are linearly spaced in wavenumber; a dispersive element coupled to the optical comb filter and configured to generate a plurality of narrowband optical signals that are linearly spaced in wavenumber from the output light signals of the optical comb filter; and a detector array coupled to the dispersive element to receive and measure the plurality of narrowband optical signals that are a linearly spaced in wavenumber, wherein at least one component of the optical subsystem is formed on a substrate.

In yet another broad aspect, at least one embodiment described herein provides an Optical Coherence Tomography (OCT) system comprising a light source configured to provide an input optical signal; a splitter coupled to the light source, the splitter configured to split a received optical signal into first and second portions; a reference arm coupled to the splitter to receive a first portion of the input optical signal and provide a reference optical signal back to the splitter; a sample arm coupled to the splitter to receive a second portion of the input optical signal and provide a sample optical signal to the splitter; an optical comb filter upstream of the spectrometer and configured to generate light signals with components that are linearly spaced in wavenumber; a spectrometer configured to receive input light signals having components that are linearly spaced in wavenumber and generate output samples corresponding to the light signals having components that are linearly sampled in wavenumber; and a computing device coupled to the spectrometer to receive the output samples and generate a spectral estimate based on the output samples, wherein at least one component of the system is formed on a substrate.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1 shows several graphs of channel wavelength, wavelength spacing and channel bandwidth versus output channel number for spectrometers having wavelength-linear outputs and wavenumber-linear outputs, respectively;

FIG. 2 is a block diagram of an example embodiment of an SD-OCT system having a spectrometer that can generate wavenumber-linear output samples;

FIG. 3 is a schematic diagram of an example embodiment of a spectrometer that can generate wavenumber-linear output samples;

FIG. 4 is a schematic diagram of an example embodiment of a Planar Concave Grating (PCG) spectrometer that can generate wavenumber-linear output samples;

FIGS. 5A and 5B show experimental data for an example embodiment of a PCG spectrometer that is designed to have a wavenumber-linear output samples;

FIG. 6 is a schematic diagram of an example embodiment of an Arrayed Waveguide Grating (AWG) spectrometer that can generate wavenumber-linear output samples;

FIG. 7 is a block diagram of an example of an alternative embodiment of an OCT system 10′ that can generate wavenumber-linear output samples; and

FIG. 8 is a diagram of another example embodiment of an optical comb filter and a dispersive element on a chip which together can generate wavenumber-linear output samples and can be used within an OCT system.

### DETAILED DESCRIPTION OF THE EMBODIMENTS

Various apparatuses or processes will be described below to provide an example of an embodiment of each claimed subject matter. No embodiment described below limits any claimed subject matter and any claimed subject matter may cover processes or apparatuses that differ from those described below. The claimed subject matter are not limited to apparatuses or processes having all of the features of any one apparatus or process described below or to features common to multiple or all of the apparatuses or processes described below. It is possible that an apparatus or process described below is not an embodiment of any claimed subject matter. Any subject matter disclosed in an apparatus or process described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein in any way, but rather as merely describing the implementation of various embodiments as described.

The terms or phrases “an embodiment,” “embodiment,” “embodiments,” “the embodiment”, “the embodiments”, “one or more embodiments”, “some embodiments”, “at least one embodiment”, “at least some embodiments” and “one embodiment” mean “one or more (but not all) embodiments of the present subject matter”, unless expressly specified otherwise.

The terms “including,” “comprising” and variations thereof mean “including but not limited to”, unless expressly specified otherwise. A listing of items does not imply that any or all of the items are mutually exclusive, unless expressly specified otherwise.

It should also be noted that the terms “coupled” or coupling as used herein can have several different meanings depending in the context in which these terms are used. For example, the terms coupled or coupling can have a mechanical, electrical or optical connotation. For example, depending on the context, the terms coupled or coupling indicate that two elements or devices can be physically, electrically or optically connected to one another or connected to one another through one or more intermediate elements or devices via a physical, an electrical or an optical element such as, but not limited to a wire, a fiber optic cable or a waveguide, for example.

It should be noted that terms of degree such as “substantially”, “about” and “approximately” as used herein mean a reasonable amount of deviation of the modified term such that the end result is not significantly changed. These terms of degree should be construed as including a deviation of up to a certain amount of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about.” The term “about” means a deviation of up to plus or minus a certain amount of the number to which reference is being made without negating the meaning of the term it modifies.

Furthermore, in the following passages, different aspects of the embodiments are defined in more detail. Each aspect so defined may be combined with any other aspect or aspects unless clearly indicated to the contrary. In particular, any feature indicated as being preferred or advantageous may be combined with at least one other feature or features indicated as being preferred or advantageous.

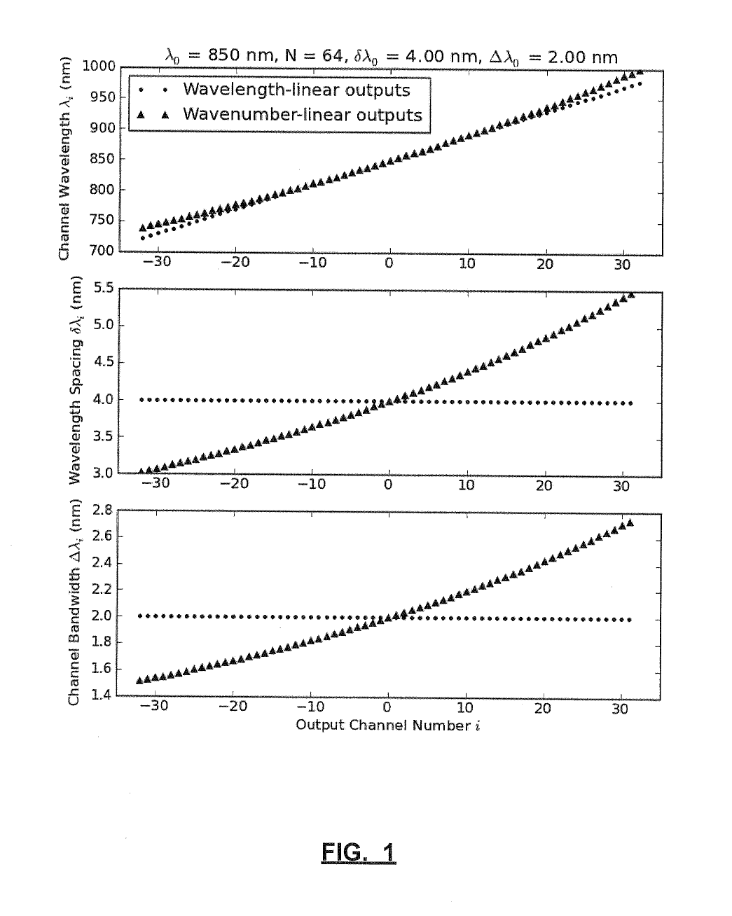

Many dispersive spectrometers have a wavelength-linear output which is not ideal for all applications. Accordingly, for some applications, it is desirable to build a spectrometer such that the spacing between output samples follows some other pattern. The various embodiments described herein are generally related to a new OCT system such that the outputs of a spectrometer in the OCT system are narrowband signals that are linearly spaced in frequency f=c/λ or equivalently linearly spaced in wavenumber k=1/λ, as shown in FIG. 1. This is especially useful in Spectral Domain Optical Coherence Tomography (SD-OCT) where a light signal is conventionally measured by a wavelength-linear spectrometer, and the data or output samples must be resampled onto a wavenumber-linear grid, resulting in an increase in computational time and a decrease in signal fidelity. The discrepancy between equal wavelength intervals and equal wavenumber intervals (and hence the decrease in OCT signal fidelity) is especially large when the total bandwidth span of the spectrometer is especially large, such as when the total bandwidth span of the spectrometer is larger than 50 nm, for example.

The top panel in FIG. 1 shows a graph of channel wavelength versus output channel number for spectrometers that generate wavelength-linear outputs and wavenumber-linear outputs. The middle panel in FIG. 1 shows a graph of wavelength spacing versus output channel number for spectrometers that generate wavelength-linear outputs and wavenumber-linear outputs. The lower panel in FIG. 1 shows a graph of channel bandwidth versus output channel number for spectrometers that generate wavelength-linear outputs and wavenumber-linear outputs. In each of these cases it is assumed that both spectrometers have the same channel wavelength and channel spacing for the center channel and the channel bandwidth is assumed to be half of the channel spacing. FIG. 1 demonstrates that the output samples provided by a wavenumber-linear spectrometer are significantly different than the output samples provided by a conventional wavelength-linear spectrometer, especially when the bandwidth is especially large.

According to the teachings herein, to implement a spectrometer that generates wavenumber-linear outputs, the outputs of a dispersive element of the spectrometer, such as a grating, can be physically rearranged into a wavenumber-linearized output using an array of waveguides integrated on a planar substrate of an integrated chip in at least one embodiment. The planar substrate can also be referred to as a substrate, a chip, a wafer, or an integrated circuit. The waveguide array is inserted between the dispersive element and the detector array of the spectrometer, and acts to rearrange the light output of the dispersive element.

The dispersive element and the detector array can be included on the same chip as the waveguide array. Alternatively, in some embodiments either or both of the dispersive element and the detector array may be located off of the chip. These wavenumber-linearized embodiments can be manufactured in an inexpensive and uncomplicated manner. The wavenumber-linear feature is particularly useful in applications where an inverse Fourier transform is performed on the recorded data, such as SD-OCT, for example.

In some embodiments, at least some elements are composed of waveguides formed on a planar substrate. In some embodiments, these waveguides can be comprised of materials that are transparent in the near infrared spectrum in the ranges typically used in OCT systems, such as, but not limited to the 850 nm, 1050 nm or 1310 nm spectral bands in some embodiments. However, it should be appreciated that in other embodiments alternative materials can be chosen that are appropriate for a particular wavelength or range of wavelengths of light. In some of the various embodiments, it can be preferable that the materials used to form waveguides have a high refractive index contrast, such as a core to cladding ratio of 1.05:1 or greater, for example, which can confine light and enable more compact photonic components as compared to materials having a low refractive index contrast. In some embodiments, waveguides can be comprised of silicon nitride, silicon oxynitride, silicon, SUB, doped glass, other polymers or another suitable material.

In some embodiments, the elements of these embodiments can be formed on a planar substrate using photolithography. However, it should be understood that photonic circuits can be fabricated by other methods, such as, but not limited to, electron beam lithography or nanoimprint lithography, for example.

In embodiments where elements are formed on a planar substrate using photolithography and where waveguides and other photonic elements on the planar substrate are made of silicon nitride, a standard silicon wafer can be used having several microns of silicon dioxide thermally grown on a top surface of the substrate as a lower waveguide cladding. In at least some of the embodiments described herein, a thickness of 3-4 microns of silicon dioxide can be used; however, it should be understood that other thicknesses can be used and may be appropriately chosen based on the wavelength range of optical input signals to be analyzed and/or processed. In some embodiments, silicon dioxide can be deposited by other techniques such as plasma enhanced chemical vapor deposition. In some embodiments, a material other than silicon dioxide may be used for a lower cladding.

Silicon nitride can then be deposited onto the planar substrate, and in some embodiments, a few hundred nanometers of stoichiometric silicon nitride can be deposited using low pressure chemical vapor deposition. An anti-reflection coating layer such as, but not limited to, Rohm and Haas AR3 can additionally be applied by spin coating onto the planar substrate, which can enhance the performance of the photolithography process. A UV-sensitive photoresist such as, but not limited to, Shipley UV210 can then be applied by spin coating onto the planar substrate.

The planar substrate can be patterned using a photolithographic patterning tool at an appropriate exposure to expose the resist with a pattern of waveguides and other devices. After being exposed, the planar substrate can be developed with MicroChemicals AZ 726MIF or another suitable developer to remove unexposed resist. A descum process can be used with a plasma etcher to remove residual resist and the pattern in the resist can be reflowed, in some embodiments for several minutes, with a hot plate to smooth out any surface roughness.

The silicon nitride on the planar substrate can be etched using inductively coupled reactive ion etching (ICP RIE) with a CHF₃/O₂ recipe. The resist mask used for etching can then be removed in an oxygen plasma or in a resist hot strip bath which contains heated solvents.

The planar substrate can be annealed in a furnace oxide tube, in some embodiments at 1200° C. for three hours. This can tend to reduce material absorption losses in embodiments where an optical source generates an optical signal at wavelengths that are near infrared.

The planar substrate can then be covered in oxide, which in some embodiments can be done by using high temperature oxide deposited in furnace tubes or by using plasma enhanced chemical vapour deposition. The planar substrate can then be diced and the end facets can be polished which can improve coupling of waveguides and other optical elements formed on the planar substrate. Alternatively, the end facets can be lithographically defined and etched using a deep reactive-ion etching process such as, but not limited to, the Bosch process, for example.

It should be noted that there may be variations to the fabrication techniques described above depending on the particular embodiment of the spectrometer that is being manufactured and/or the particular use of the spectrometer.

It should further be noted that in an alternative embodiment, the array of waveguides may be implemented in a non-planar arrangement such as waveguides written in a 3D pattern by laser writing in a photosensitive material. In yet another embodiment, the array of waveguides may be implemented by an array of optical fibers.

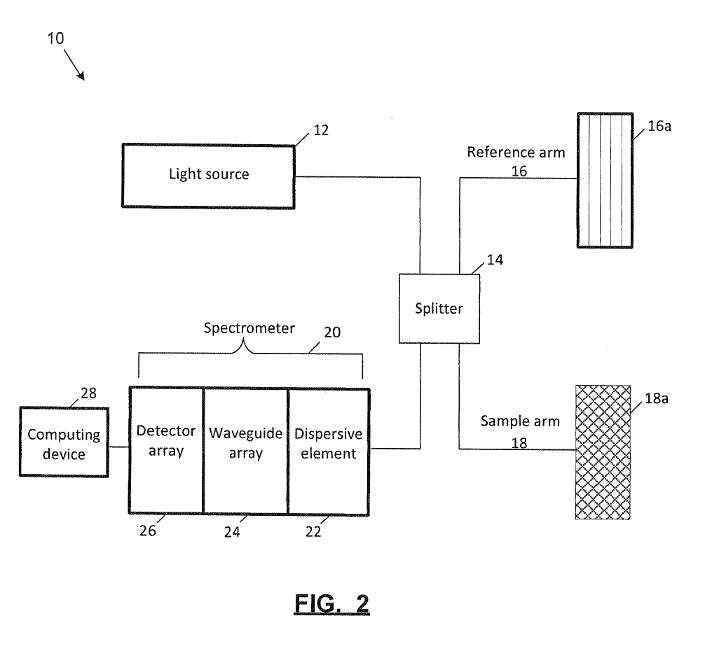

Referring now to FIG. 2, shown therein is an example embodiment of an SD-OCT system 10 having a spectrometer that generates wavenumber-linear outputs. In general, the SD-OCT system 10 comprises a light source 12, a splitter 14, a reference arm 16, a reference element 16a, a sample arm 18 that leads to a sample 18a, a spectrometer 20 including a dispersive element 22, a waveguide array 24 located on a chip, a detector array 26, and a computing device 28. The SD-OCT system 10 is implemented such that one or more components are integrated on a planar substrate (i.e. on an integrated chip). In some cases, all of the components are integrated on the same chip. In other cases, not all of the components need to be located on the same chip. However, it is preferred that at least the dispersive element 22 and the waveguide array 24 are located on-chip on either a common chip or separate chips, for example.

The light source 12 generates an input optical signal that is generally broadband in terms of wavelength. The light source 12 can be implemented by one of a superluminescent diode, a fiber amplifier, a femtosecond pulsed laser, a supercontinuum source, an optical parametric oscillator, a frequency comb, or any other broadband source or near-infrared light source, that may be suitable given the use of the SD-OCT system 10.

The splitter 14 is a beam splitter that splits the input optical signal into two beams (i.e. first and second portions of the input optical signal) to generate a reference beam for the reference arm 16 and a sample beam for the sample arm 18. In some embodiments, the splitter 14 can have a broad bandwidth and can operate with a flat 50:50 splitting ratio for all wavelengths of interest, which can tend to provide low optical signal losses. Alternatively, in some embodiments, the splitter 14 can have a splitting ratio other than 50:50 to improve the quality of the interference signal generated from the light signals provided by the reference arm 16 and the sample arm 18 to the spectrometer 20. The splitter 14 can be one of a y-splitter, a multimode interference splitter, a directional coupler, a Mach-Zehnder splitter or another optical beam splitter that is capable of splitting a received optical signal into split optical signals and directing the split optical signals towards two or more optical pathways.

The reference arm 16 receives the first portion of the input optical signal and directs this signal towards the reference element 16a which reflects the first portion of the input optical signal. The reflected first portion of the input optical signal is sent to the spectrometer 20 by the splitter 14. Accordingly, the reference arm 16 introduces a delay that allows, for example, depth analysis of the sample 18a when the reflected first portion of the input optical signal is delayed by a known path length close to the depth of the sample 18a at a particular point of interest for imaging.

The sample arm 18 receives the second portion of the input optical signal and directs this signal toward the sample 18a which reflects the second portion of the input optical signal. The reflected second portion of the input optical signal is sent to the spectrometer 20 by the splitter 14. The reflected second portion of the input optical signal can be used, in combination with the optical signal from the reference arm, to generate a surface or sub-surface image of the sample 18a.

The reference arm 16 and the sample arm 18 can be implemented using free space optical components, fiber optics, or by a waveguide having a desired effective refractive index. In some embodiments, at least one of the reference arm 16 and the sample arm 18 can be comprised of materials that are transparent in the wavelength range of the optical signal provided by the light source 12, such as silicon, silicon nitride, doped glass, other polymers or other suitable materials for guiding light in a wavelength range of interest, depending on the use of the SD-OCT system 10.

In some embodiments, the reference element 16a can be a controllable delay element that is configured to adjust the refractive index of a portion of the reference arm 16 to introduce the delay. In some embodiments, the controllable delay element can adjust the refractive index of the reference arm 16 by changing the temperature of a portion of the reference arm 16. In alternative embodiments, the controllable delay element can adjust the refractive index of the reference arm 16 by employing the electro-optic effect. In some embodiments, the reference element 16a can have a serpentine shape and a path length that is longer than the path length of the sample arm 18 and the sample 18a in order to provide the delay.

The optical signals from the reference arm 16 and the sample arm 18 are combined by either passing them through the same optical element which initially split the two signals, or by passing them through a recombiner (not shown). Accordingly, in this example embodiment, the splitter 14 is used to recombine the optical signals from the reference arm 16 and the sample arm 18; however, other elements may be used in other embodiments to implement the recombiner.

The spectrometer 20 generates a spectral interferogram by generating output samples representative of the interference between the reflected first and second portions of the input optical signal as a function of wavelength. The output samples are then sent to the computing device 28 where the data is processed to generate an OCT image.

The dispersive element 22 receives the reflected first and second portions of the input optical signal and generates a dispersed spectrum along an output focal curve which is representative of the spectrum of the interference signal (i.e. of the interference between the reflected first and second portions of the input optical signal). The dispersed spectrum may be considered to comprise a plurality of spatially separated spectral components. The dispersive element 22 can be implemented by an Arrayed Waveguide Grating (AWG) or a Planar Concave Grating (PCG), for example. In general, the dispersed spectrum that is generated by the dispersive element 22 is in a linear wavelength format; in other words, there is a linear relationship between wavelength and position along the output focal curve. In some embodiments, the linear relationship may be disposed near the output focal curve, i.e. at an output of the AWG or PCG.

The waveguide array 24 has a plurality of waveguides that receive and sample the dispersed spectrum to generate a plurality of narrowband optical signals (i.e. receive the spatially separated components of light and capture or generate a plurality of narrowband optical signals). In some embodiments, the input ports of the waveguides are nonlinearly spaced along the output or the output focal curve of the dispersive element 22 such that they receive narrowband signals that are equally spaced in wavenumber; in other words, the narrowband optical signals have a linear wavenumber format. In some embodiments, the input pitch of the waveguides in the waveguide array 24 is nonlinearly spaced such that the center wavelengths of the narrowband optical signals that are received (i.e. captured) are equally spaced in wavenumber when plotted against the output channel number i. The output of the waveguide array 24 may be referred to as having a linear wavenumber format. The waveguides in the waveguide array 24 transmit the narrowband optical signals to the detector array 26 to generate output samples having a linear wavenumber format.

The detector array 26 is an array of detector elements such as, but not limited to, surface-illuminated detector pixels or integrated waveguide photodetectors, that are arranged to receive and measure the plurality of narrowband optical signals from the waveguide array 24 thereby providing information about the sample 18a. In some embodiments, the center wavelengths of the plurality of narrowband optical signals from the waveguide array 24 are linearly spaced in wavenumber and the detector elements in the detector array 26 are linearly arranged to provide a linearly spaced array of pixels. Accordingly, the detector array 26 measures data that corresponds to the plurality of narrowband optical signals having a linear wavenumber format and this measured data forms the output data of the spectrometer 20.

It is understood that the detector array 26 may utilize readout electronics (not shown) that are used to convert the signals measured by the detector elements into a suitable output data format that can be used by the computing device 28. In some embodiments, the readout electronics include a Field Programmable Gate Array or a microcontroller that provides clock and control signals to the detector elements in order to read the measured data from the detector elements and then format the measured data using a suitable output data format. For example, the output data format can be a USB format so that a USB connection can be used between the detector array 26 and the computing device 28. In some embodiments, if the detector elements generate output analog signals, then the readout electronics also include a suitable number of analog to digital converters with a suitable number of channels. Accordingly, the detector array 26 provides output samples for the plurality of narrowband signals generated by the spectrometer 20.

It is important to note that since the data measured by the detector array 26 already has the desired wavenumber-linear spacing, there is no need for an interpolating algorithm to transform the measured signals from a linear wavelength format to a linear wavenumber format as is required in conventional OCT systems. The result of removing the interpolation algorithm in the SD-OCT system 10 is that OCT image acquisition is faster and less computationally intensive, and OCT image quality is improved with the various embodiments described herein. The increase in image quality is due to the lack of artifacts and signal roll-off introduced in the image by the interpolation process that is used in conventional designs. In particular, this is because the rescaling that is done during interpolation is imperfect since data is undersampled on the blue end of the spectrum which leads to increased signal roll-off versus imaging depth. OCT image quality is also improved if the width of the input end of each waveguide in the waveguide array 24 is designed such that each waveguide captures an equal bandwidth in wavenumber. Additionally, in at least some embodiments the number of output samples generated by the spectrometer 20 is a power of two. In other words, the number of output samples N is 2̂n where n is an integer. In this embodiment the efficiency of the Fourier transform function used by the computing device 28 is improved, for example.

The computing device 28 receives the measured data from the detector array 26 and processes the measured data by using a processing algorithm to produce processed data in a certain format. For example, since the data measured by the detector array 26 is linearly spaced in wavenumber then the computing device 28 can use an inverse Fourier transform to analyze the output samples to obtain the OCT image of the sample. The computing device 28 can be implemented by any suitable processor that may be used in a desktop computer, laptop, tablet, smart phone, or any other suitable electronic device. Alternatively, the computing device 28 can be implemented using dedicated hardware or an Application Specific Integrated Circuit (ASIC).

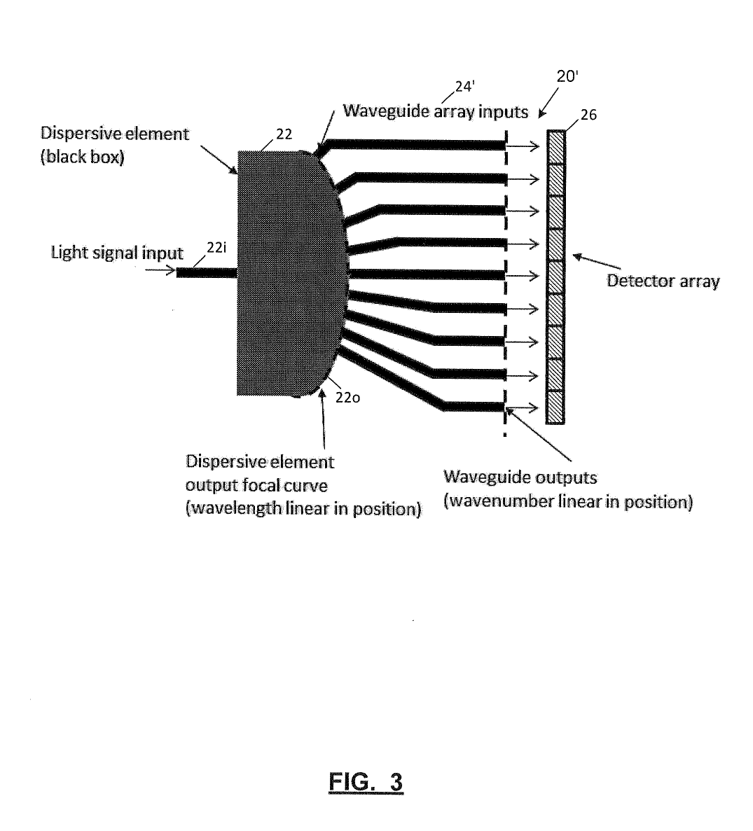

Referring now to FIG. 3, shown therein is a schematic of an example embodiment of a spectrometer 20′ that can be used with the SD-OCT system 10. The dispersive element 22 has a light signal input 22i (which can also be referred to as an input optical signal), and an output focal curve 22o along which the spectrum of the input signal is dispersed in a linear wavelength format (in some alternative embodiments, the spectrum of the input signal may be dispersed in a linear wavelength format at an output of the dispersive element 22 near the output focal curve). However, the waveguides of the waveguide array 24′ are arranged such that the input ports of these waveguides are nonlinearly spaced in a certain way along the output focal curve 22o of the dispersive element 22 which rearranges the spatial light output of the dispersive element 22 from a linear-wavelength spacing to a linear-frequency or linear-wavenumber spacing (the word format can also be used instead of the word spacing). In some embodiments, if a linear array of detectors is used in the detector array 26, then the output ends of the waveguide array 24′ are linearly spaced.

In some embodiments, the width of the waveguides at the input end of the waveguide array 24 can also be tailored to equalize the wavenumber-bandwidth of each waveguide in order to not lose any portion of the narrowband optical signals at the input of the waveguides. In other words, the physical width of the input end (which can also be referred to as input port) of each waveguide in the waveguide array 24 can be designed such that the bandwidth of each received spectral band is substantially constant in wavenumber. The width of each waveguide can be designed by analyzing the mode overlap of the optical mode at the input of the dispersive element 22 with the optical mode at the input of the waveguide, using either analytical or numerical methods. A particular waveguide width may be designed that captures the desired bandwidth for a corresponding narrowband optical signal. This is in contrast to conventional spectrometers, in which the bandwidth and spacing of each spectral band are both substantially constant in wavelength (not wavenumber). For the case of planar photonic spectrometers, tailoring the width of the input of the waveguides can ensure that the amount of light intercepted is maximized, optimizing the total throughput of the spectrometer by minimizing the light scattered away at the disperser/waveguide interface.

Equations can be used to describe the construction of the waveguide array 24. For example, given a desired central wavenumber k₀ and a wavenumber spacing δk, one can construct a list of wavenumber values kᵢ for each i^{th} output as shown in equation 3:

kᵢ=k₀+i*δk (3)

where i is an integer between −N/2 and N/2, and N is the number of outputs. The list of linearly-spaced wavenumbers kᵢ can then be converted to a list of nonlinearly-spaced wavelengths λᵢ using equation 4.

λᵢ=2π/kᵢ (4)

Using parameters of the dispersive element output including the position (x₀, y₀) where the center wavelength λ₀=2π/k₀ is focused, the shape of the output focal curve, and the linear dispersion in μm/nm along the output focal curve, a continuous function can be determined that describes the focal position (x, y) of any wavelength λ. This function can then operate on each desired wavelength λᵢ to determine the positions (xᵢ, yᵢ) where the input end of each waveguide in the waveguide array 24 should be placed. As described previously, in some embodiments, the width of the input end of each waveguide in the waveguide array 24 can additionally be tailored to maintain a constant spectral bandwidth Δk for the light signals that are captured by each waveguide. This can compensate for the constant Δλwhich would typically be acquired, as well as for 2^{nd} order effects such as the effective index and mode size being functions of wavelength.

In embodiments in which the output focal curve of the dispersive element 22 sits along a circle (which is often the case for AWG or PCG dispersive elements), then the positions of the waveguide inputs can be described as having an angular separation that gradually increases from one end of the array (i.e. the blue spectrum end) to the other end (i.e. the red spectrum end), instead of a constant angular separation δθ as in the conventional case.

In some embodiments, the input ports of the waveguides in the waveguide array 24′ may be arranged such that the input ports are not located exactly along the output focal curve 22o, but instead are offset from the output focal curve. In this case the position of the input ports may be described as being located along an output of the dispersive element 22 instead of along the output focal curve 22o.

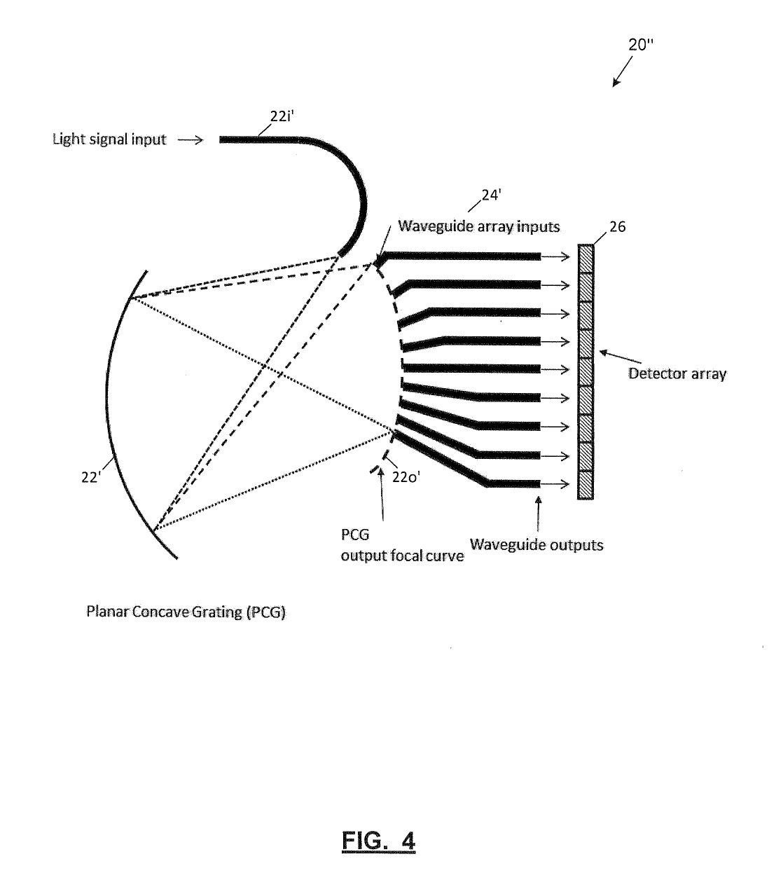

Referring now to FIG. 4, shown therein is a schematic diagram of an example embodiment of a PCG on-chip spectrometer 20″ that can generate wavenumber-linear outputs. The PCG 22′ has a light signal input 22i′ and an output focal curve 22o′ where the spectrum of the input signal is dispersed in a linear wavelength format. The input ends of the waveguides in the waveguide array 24′ are physically arranged in a non-linear fashion (according to equations 3 and 4) at the output focal curve 22o′ in order to generate a plurality of narrowband optical signals having a linear wavenumber format and transmit them to the detector array 26 for detection and measurement to generate output samples having a linear wavenumber format.

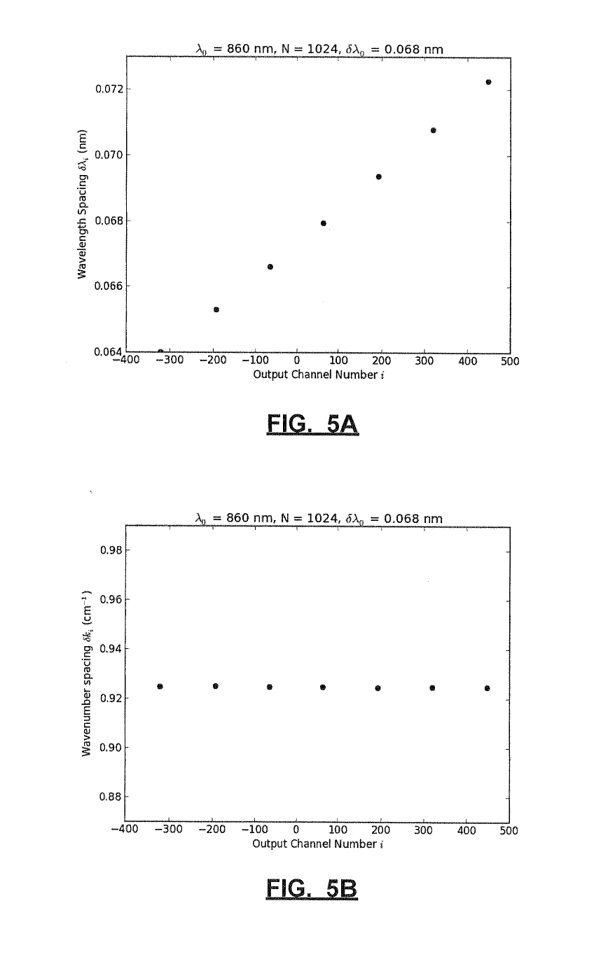

Referring now to FIGS. 5A and 5B, shown therein is experimental data for an example embodiment of a PCG spectrometer that is designed to have a wavenumber-linear output. In this example, the PCG spectrometer is designed to have a wavenumber channel spacing of 0.92 cm⁻¹ which is substantially constant for all of the outputs. This corresponds to a wavelength channel spacing of 0.068 nm at the center output channel. The linear wavenumber format of the output samples is obtained by a nonlinear spacing of the input ports of the waveguides in a waveguide array along the output focal curve of the PCG. FIGS. 5A and 5B show the same data plotted with the y axis representing wavelength and wavenumber, respectively. FIG. 5A demonstrates that the output does not have a linear wavelength format, while FIG. 5B demonstrates that a wavenumber-linearized output was achieved. It should be noted that a sparse representation of the outputs is plotted for clarity.

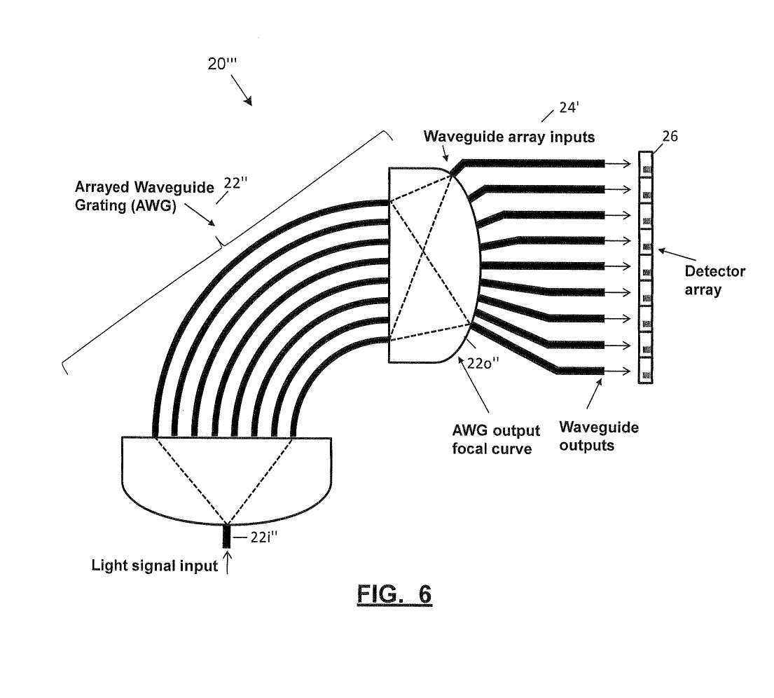

Referring now to FIG. 6, shown therein is a schematic diagram of an example embodiment of an AWG on-chip spectrometer 20′″ that can generate wavenumber-linear outputs. The AWG 22″ has a light signal input 22i″ and an output focal curve 22o″ where the spectrum of the input signal is dispersed in a linear wavelength format. Once again, the input ends of the waveguides in the waveguide array 24′ are physically arranged in a nonlinear fashion (according to equations 3 and 4) at the output focal curve 22o″ in order to generate the plurality of narrowband optical signals in a linear wavenumber format and transmit them to the detector array 26 for detection and measurement to generate output samples having a linear wavenumber format.

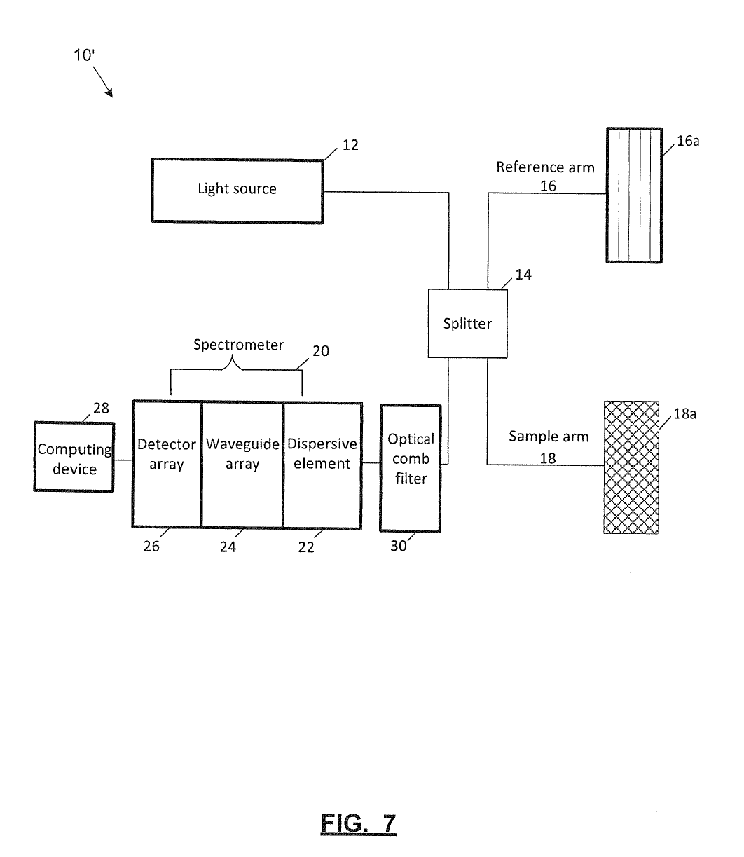

Referring now to FIG. 7, shown therein is a schematic diagram of an example of an alternative embodiment of an OCT system 10′ that can generate wavenumber-linear outputs. In the OCT system 10′, the light source 12 provides an input optical signal that is broadband, and an optical comb filter 30 is placed before the dispersive element 22 of the spectrometer 20. The optical comb filter 30 can be integrated as part of the spectrometer 20 or the optical comb filter 30 can be physically separate from the spectrometer 20. In an alternative embodiment, the optical comb filter 30 can be located after the light source 12 or be part of the light source 12.

The optical comb filter 30 removes some of the light that is sent to the spectrometer 20, such that the output of the optical comb filter 30 consists of a filtered optical signal having spectral bands whose spacing and bandwidth are substantially constant in wavenumber. In other words, the filtered optical signal comprises narrowband optical signals, or comb lines, in a linear wavenumber format. The filtered light signal then passes through the dispersive element 22 and then to the detector array 26. In some embodiments, the waveguide array 24 is nonlinearly spaced to provide a plurality of wavenumber-linear narrowband optical signals to the detector array 26; preferably the waveguide array 24 has one waveguide per narrowband optical signal. In alternative embodiments, the waveguide array 24 may be linearly spaced or there may be no waveguide array. In cases where there are no waveguides or where the waveguides are linearly spaced, some detector pixels in the detector array 26 are illuminated by a narrowband optical signal while some detector pixels may not be illuminated because they fall in between the comb lines. The output samples generated by the detector array 26 are wavenumber-linear so long as no more than one comb line of the filter output falls within a single pixel of the detector array 26. In other words, it does not matter if the spectrometer 20 is wavelength-linear, as long as the output of the optical comb filter 30 has narrow enough bands such that one wavenumber-linear band fits inside one wavelength-linear pixel element across the entire array of pixels of the detector array 26. However, a wavenumber-linear spectrometer will make more efficient use of the detector pixels since a one-to-one mapping of comb lines to detector pixels can be achieved without leaving unused detector pixels.

In some embodiments, the optical comb filter 30 can be implemented by a standing-wave cavity or a traveling-wave cavity. In some embodiments, the optical comb filter 30 may be implemented by a discrete component, such as a standing-wave Fabry-Perot cavity, using either free space optical components or fiber optic components. However, in some preferred embodiments, the optical comb filter 30 can be integrated onto the same chip as the dispersive element 22 for ease of implementation, reduction in overall size, reduction in component cost, and reduction in system assembly costs. For example, a standing-wave Fabry-Perot cavity can be implemented on-chip using reflective elements such as mirrors or photonic crystals. As another example, a traveling-wave cavity can be implemented on-chip using a large-radius microring resonator, a racetrack resonator, a microdisk resonator, or a whispering-gallery-mode resonator. For either the standing-wave or traveling-wave case, the channel spacing of the optical comb filter 30 is set by its Free Spectral Range (FSR) which has a frequency spacing δv=c/(2nL), where c is the speed of light, n is the group index of refraction, and 2L is the total round trip path length of the cavity. The dispersive element 22 can be implemented by a PCG or an AWG, for example.

In another alternative embodiment, the optical comb filter 30 and light source 12 can be integrated together on a chip for ease of implementation, reduction in overall size, reduction in component cost, and reduction in system assembly costs. This chip containing the light source 12 and the optical comb filter 30 may be separate from the chip containing the dispersive element 22 and the waveguide array 24, or alternatively all of these components may be located on the same chip.

In some embodiments, the light source 12 may be a frequency comb. In other words, the light source 12 directly outputs a frequency comb consisting of a plurality of narrowband optical signals in a linear wavenumber format without the use of a separate comb filter. The frequency comb may be implemented by an optical parametric oscillator, a femtosecond pulsed laser, or a modulated continuous-wave laser, for example. This embodiment where the light source 12 is a frequency comb is similar to the embodiment of a continuous broadband source, such as a superluminescent diode or supercontinuum source, which is filtered by an optical comb filter. In particular, in some embodiments, the waveguide array 24 is nonlinearly spaced to provide a plurality of wavenumber-linear narrowband optical signals to the detector array 26, preferably providing one waveguide per narrowband optical signal. In alternative embodiments, the waveguide array 24 may be linearly spaced or there may be no waveguide array.

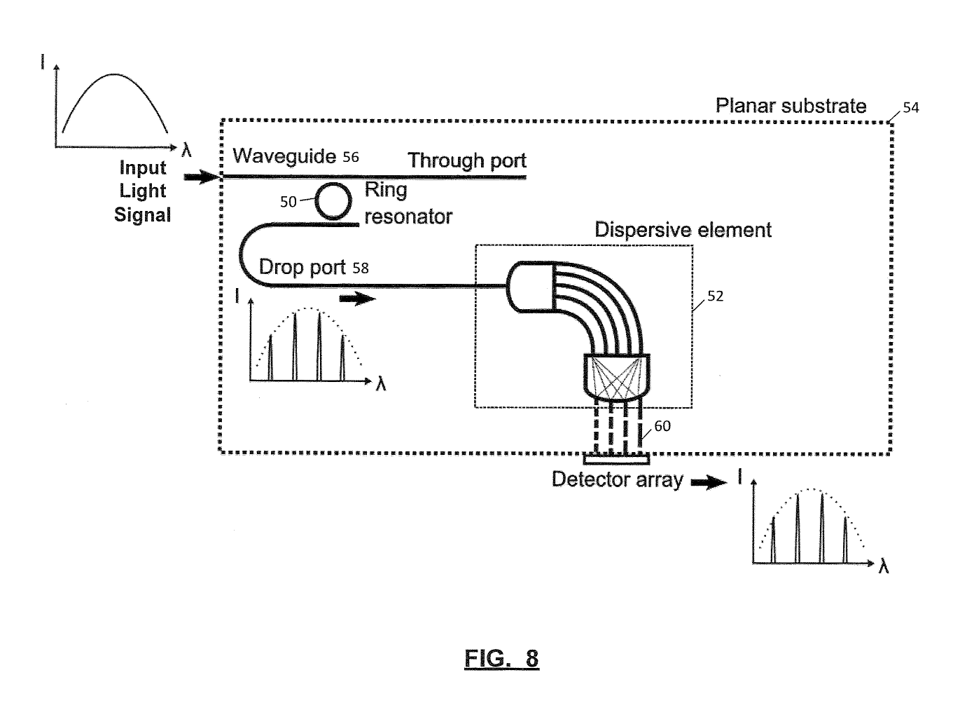

Referring now to FIG. 8, shown therein is a diagram of another example embodiment of an optical comb filter 50 and a dispersive element 52 on a chip 54 which together can generate wavenumber-linear outputs and can be used within an OCT system. This embodiment includes a device input that receives an input light signal, for example from the splitter 14 in an OCT system. The input light signal is then provided to the optical comb filter 50 via a waveguide 56. In some embodiments, the optical comb filter 50 can be thermally coupled to an integrated thin-film heater (not shown) to regulate its temperature so that it filters the proper frequencies. The output of the optical comb filter 50 is a plurality of narrowband optical signals that are substantially in a wavenumber-linear format. In this example embodiment, the optical comb filter 50 can be a ring resonator. The output of the optical comb filter 50 is provided to a drop port 58 and is then sent to the dispersive element 52 which disperses the spectrum along an output focal curve. A plurality of output waveguides 60 then receives the spatially dispersed optical signal to generate a second plurality of narrowband signals that are wavenumber-linear due to the filtering provided by the optical comb filter 50. The output waveguides 60 transport these signals to the detector array. In some embodiments, the input ports of the output waveguides 60 are linearly arranged since the spatially dispersed optical signal from the dispersive element 52 already has components in a linear wavenumber format. In more preferred embodiments, the input ports of the output waveguides 60 are nonlinearly arranged to match the comb lines of the filtered optical signal such that each waveguide captures one comb line.

It should be noted that not all of the components of the OCT systems 10 and 10′ or that shown in FIG. 8 need be located on a chip, or necessarily on the same chip. However, it is preferable that at least the waveguide array 24, 24′, 60 is located on a chip. It is more preferable that the dispersive element 22, 22′, 22″, 52 is also located on a chip, and yet more preferable that the waveguide array 24, 24′, 60 and the dispersive element 22, 22′, 22″, 52 are located on the same chip.

The various embodiments of the OCT systems described herein that provide narrowband signals that are linearly spaced in wavenumber to the detector array of a spectrometer provides several advantages. Firstly, this arrangement results in the removal of a data processing step from conventional OCT systems which reduces the complexity and improves the speed of the signal processing needed to implement an SD-OCT system. Secondly, OCT image quality is improved, because of the avoidance of data rescaling which is conventionally used and is an imperfect process that worsens the signal roll-off versus imaging depth in a typical OCT setup. The various embodiments of the OCT systems described herein also avoid the need for additional dispersive optical elements (e.g. a prism or grating) that are designed to convert the usual wavelength-linear dispersion into wavenumber-linear dispersion thus simplifying the implementation of the OCT system. Furthermore, since the various embodiments of the OCT systems described herein can be monolithically integrated such that the dispersive element and the waveguide array as well as other components are on a planar substrate, these elements can be automatically pre-aligned in chip manufacturing which results in an OCT system that is simple, inexpensive, small, and robust.

It should be understood that the various embodiments described herein which use existing optical components in a spectrometer or an OCT system to generate samples that have a wavenumber linear format may be used in any other applications, systems or methods which require data with a wavenumber linear format.

At least some of the elements of the various OCT embodiments described herein, such as the a portion of the readout electronics and the computing device 28, may be implemented via software and written in a high-level procedural language such as object oriented programming or a scripting language. Accordingly, the program code may be written in C, C⁺⁺ or any other suitable programming language and may comprise modules or classes, as is known to those skilled in object oriented programming. Alternatively, at least some of the elements that are implemented via software may be written in assembly language, machine language or firmware as needed. In either case, the program code can be stored on a storage media or on a computer readable medium that is readable by a general or special purpose programmable computing device having a processor, an operating system and the associated hardware and software that is necessary to implement the functionality of at least one of the embodiments described herein. The program code, when read by the computing device, configures the computing device to operate in a new, specific and predefined manner in order to perform at least one of the methods described herein.

While the above description provides examples of various embodiments, it will be appreciated that some features and/or functions of the described embodiments are susceptible to modification without departing from the principles of operation of the described embodiments. Accordingly, what has been described above has been intended to be illustrative of the subject matter described herein and non-limiting and it will be understood by persons skilled in the art that other variants and modifications may be made without departing from the scope of the claimed subject matter as defined in the claims appended hereto. Furthermore, the scope of the claims should not be limited by the preferred embodiments and examples, but should be given the broadest interpretation consistent with the description as a whole.

1. A spectrometer for use with a Spectral Domain Optical Coherence Tomography (SD-OCT) system, the spectrometer comprising:
a dispersive element configured to generate a dispersed spectrum in a linear wavelength format from an input optical signal received by the spectrometer;
a waveguide array coupled to the dispersive element and having a plurality of waveguides with input ports being configured to receive and sample the dispersed spectrum to generate a plurality of narrowband optical signals in a linear wavenumber format; and
a detector array coupled to the waveguide array to receive and measure the plurality of narrowband optical signals having a linear wavenumber format and generate output samples having a linear wavenumber format.

2. The spectrometer of claim 1, wherein the input ports of the plurality of waveguides are spaced apart non-linearly along an output of the dispersive element.

3. The spectrometer of claim 2, wherein the input ports of the plurality of waveguides are spaced apart non-linearly along an output focal curve of the dispersive element.

4. The spectrometer of claim 1, wherein the input ports of the waveguides have widths that are sized so that the bandwidth of each narrowband optical signal from the plurality of narrowband optical signals is substantially constant in wavenumber.

5. The spectrometer of claim 1, wherein the number of generated output samples is equal to 2̂n where n is an integer.

6. The spectrometer of claim 1, wherein one or more components of the spectrometer is located on a substrate.

7. The spectrometer of claim 6, wherein the dispersive element and the waveguide array are located on a shared substrate and the detector array is not located on the shared substrate.

8. A Spectral Domain Optical Coherence Tomography (SD-OCT) system comprising:
a light source configured to provide an input optical signal;
a splitter coupled to the light source, the splitter configured to split the input optical signal into first and second portions;
a reference arm coupled to the splitter to receive the first portion of the input optical signal and provide a reference optical signal to the splitter;
a sample arm coupled to the splitter to receive the second portion of the input optical signal and provide a sample optical signal to the splitter;
a spectrometer coupled to the splitter to receive an interference signal resulting from a combination of the reference optical signal and the sample optical signal and generate output samples, the output samples being representative of the interference signal and linearly spaced in wavenumber; and
a computing device coupled to the spectrometer to receive the output samples and generate an image based on the interference signal;
wherein, one or more components of the system are formed on a substrate.

9. The system of claim 8, wherein the spectrometer is defined according to claim 1.

10. The system of claim 8, wherein the interference signal received by the spectrometer is made up of a plurality of narrowband optical signals in a linear wavenumber format.

11. The system of claim 10, wherein the system has at least two components on different substrates.

12. The system of claim 10 further comprising an optical comb filter that is configured to receive input optical signals and generate the plurality of narrowband optical signals to have a linear wavenumber format, wherein the spectrometer comprises a dispersive element and a detector array coupled to the dispersive element.

13. The system of claim 12, wherein the optical comb filter is configured to generate the plurality of narrowband optical signals to have bandwidths that are smaller than an optical channel spacing of detector pixels of the detector array.

14. The system of claim 12, wherein the optical comb filter comprises one of a microring resonator, a racetrack resonator, a microdisk resonator, a whispering-gallery-mode resonator, or a Fabry-Perot resonator.

15. The system of claim 12, further comprising a waveguide array that is disposed to couple outputs of the dispersive element to inputs of the detector array.

16. The system of claim 12, wherein the optical comb filter is coupled between the splitter and the dispersive element.

17. The system of claim 12, wherein the optical comb filter is coupled between the light source and the splitter.

18. The system of claim 12, wherein the dispersive element and the optical comb filter are formed on a common substrate.

19. The system of claim 12, wherein the light source and the optical comb filter are formed on a common substrate.

20. The system of claim 10, wherein the light source is configured to output a frequency comb consisting of a plurality of narrowband optical signals in a linear wavenumber format.

21. A use in a Spectral Domain Optical Coherence Tomography (SD-OCT) system of a waveguide array in a spectrometer, the waveguide array having a plurality of waveguides with input ports being configured to receive and sample a dispersed spectrum that is generated by a dispersive element of the spectrometer, such that the waveguide array generates a plurality of narrowband optical signals in a linear wavenumber format.

22. The use of claim 21, wherein input ports of the plurality of waveguides are spaced apart non-linearly along an output of the dispersive element.

23. The use of claim 21, wherein the input ports of the waveguides have widths that are sized so that a bandwidth of each of the plurality of narrowband optical signals that is sampled is substantially constant in wavenumber.

24. The use of claim 21, wherein the waveguide array is located on a substrate.
